(19) United States
(12) Patent Application Publication
(10) Pub. No.: US 2006/0038767 A1
(43) Pub. Date: Feb. 23, 2006

(54) Gate line driving circuit

(76) Inventors: Tetsuya Nakamura, Moriguchi-shi (JP); Seiji Kawaguchi, Hirakata-shi (JP); Masahiko Takeoka, Yamatokoriyama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/206,768

(22) Filed: Aug. 19, 2005

(30) Foreign Application Priority Data
Aug. 20, 2004 (JP) 2004-240799

(51) Int. Cl. G09G 3/36

(52) U.S. Cl. 345/100

(57) ABSTRACT

A gate line driving circuit includes a shift register section that selects gate lines for gradation display and for black insertion, and an output circuit that outputs a driving signal to the gate line which is selected by the shift register section. In particular, the output circuit is configured to obtain an overlap between an output period of a driving signal to each selected gate line and an output period of a driving signal to a gate line that is driven in precedence to the selected gate line, and independently control a first preliminary driving period corresponding to the overlap for gradation display and a second preliminary driving period corresponding to the overlap for black insertion.

### CROSS-REFERENCE TO RELATED APPLICATIONS

This application is based upon and claims the benefit of priority from prior Japanese Patent Application No. 2004-240799, filed Aug. 20, 2004, the entire contents of which are incorporated herein by reference.

### BACKGROUND OF THE INVENTION

1. Field of the Invention

The present invention relates to a gate line driving circuit that is applied to an OCB (Optically Compensated Birefringence) mode liquid crystal display panel.

2. Description of the Related Art

Flat-panel display devices, which are typified by liquid crystal display devices, have widely been used as display devices for computers, car navigation systems, TV receivers, etc.

The liquid crystal display device generally includes a liquid crystal display panel including a matrix array of liquid crystal pixels, and a display panel control circuit that controls the display panel. The liquid crystal display panel is configured such that a liquid crystal layer is held between an array substrate and a counter substrate.

The array substrate includes a plurality of pixel electrodes that are arrayed substantially in a matrix, a plurality of gate lines that are arranged along rows of the pixel electrodes, a plurality of source lines that are arranged along columns of the pixel electrodes, and a plurality of switching elements that are arranged near intersections between the gate lines and the source lines. Each of the switching elements is formed of, e.g. a thin-film transistor (TFT), and turned on to apply a potential of one source line to one pixel electrode when one gate line is driven. On the counter substrate, a common electrode is provided to face the pixel electrodes arrayed on the array substrate. Each pair of pixel electrode and common electrode is associated with a pixel area of the liquid crystal layer to form a pixel, and controls the alignment state of liquid crystal molecules in the pixel area by an electric field obtained between the electrodes. The display panel control circuit includes a gate driver that drives the gate lines, a source driver that drives the source lines, and a controller that controls operational timings of the gate driver and source driver.

In the case where the liquid crystal display device is used for a TV receiver that principally displays a moving image, a liquid crystal display panel of an OCB mode, in which liquid crystal molecules exhibit good responsivity, is generally employed (see Jpn. Pat. Appln. KOKAI Publication No. 2002-202491). In the liquid crystal display panel, the liquid crystal molecules are aligned in a splay alignment before supply of power. This splay alignment is a state where the liquid crystal molecules are laid down, and obtained by alignment films which are disposed on the pixel electrode and the counter electrode and rubbed in parallel with each other. The liquid crystal display panel performs an initializing process upon supply of power. In this process, a relatively strong electric field is applied to the liquid crystal molecules to transfer the splay alignment to a bend alignment. A display operation is performed after the initializing process.

The reason why the liquid crystal molecules are aligned in the splay alignment before supply of power is that the splay alignment is more stable than the bend alignment in terms of energy in a state where the liquid crystal driving voltage is not applied. As a characteristic of the liquid crystal molecules, the bend alignment tends to be inverse-transferred to the splay alignment if a state where no voltage is applied or a state where a voltage lower than a level at which the energy of splay alignment is balanced with the energy of bend alignment is applied, continues for a long time. The viewing angle characteristic of the splay alignment significantly differs from that of the bend alignment. Thus, a normal display is not attained in this splay alignment.

In a conventional driving method that prevents the inverse transfer from the bend alignment to the splay alignment, a high voltage is applied to the liquid crystal molecules in a part of a frame period for a display of a 1-frame image, for example. This high voltage corresponds to a pixel voltage for a black display in an OCB-mode liquid crystal display panel, which is a normally-white type, so this driving method is called “black insertion driving.” In the meantime, in the black insertion driving, the visibility, which lowers due to retinal persistence occurring on a viewer's vision in a moving image display, is improved by discrete pseudo-impulse response of luminance.

A pixel voltage for black insertion and a pixel voltage for gradation display are applied to all liquid crystal pixels on a row-by-row basis in one frame period, i.e. one vertical scanning period (V). The ratio of a storage period of the pixel voltage for black insertion to a storage period of the pixel voltage for gradation display is a black insertion ratio. In a case where each gate line is driven for black insertion in a half of one horizontal scanning period, i.e. H/2 period, and is driven for gradation display in a subsequent H/2 period, the vertical scanning speed becomes twice higher than in the case where black insertion is not executed. Since the value of the pixel voltage for black insertion is common to all pixels, it is possible to drive, for instance, two gate lines together as a set. In a case where two gate lines of each set are driven together for black insertion in a 2H/3 period, and are sequentially driven for gradation display in a 4H/3 period (2H/3 for each of two gate lines), the vertical scanning speed becomes 1.5 times higher than in the case where black insertion is not executed.

In the OCB liquid crystal display panel using low-temperature polysilicon, the resistance of the gate line is higher than in the case of using amorphous silicon. In particular, in a large-sized panel of, e.g. 32 inches, the time constant, which depends on the wiring resistance and parasitic capacitance of the gate line, increases, and the rising of the gate line potential corresponding to the driving signal, which is output from the gate driver to the gate line, becomes dull. Consequently, a time period in which the switching element is not completely rendered conductive, increases. In particular, when black insertion driving is executed, each gate line is driven in units of a period shorter than a normal 1H period. Thus, there is a tendency that the pixel voltage of the liquid crystal pixel cannot transit to a level equal to the source line potential during this driving period.

### BRIEF SUMMARY OF THE INVENTION

The object of the present invention is to provide a gate line driving circuit that is capable of solving a problem of incomplete transition of a pixel voltage due to the time constant of a gate line in black insertion driving for maintaining the bend alignment of liquid crystal molecules.

According to the present invention, there is provided a gate line driving circuit that drives a plurality of gate lines, which are assigned to rows of pixels arranged substantially in a matrix, the gate line driving circuit comprising: a selecting section that selects the gate lines for gradation display and for non-gradation display; and an output circuit that outputs a driving signal to the gate line which is selected by the selecting section, the output circuit being configured to obtain an overlap between an output period of a driving signal to each selected gate line and an output period of a driving signal to a gate line that is driven in precedence to the selected gate line, and independently control a first preliminary driving period during which the output period of the driving signal to the gate line selected for gradation display overlaps the output period of the driving signal to the gate line that is driven in precedence to the gate line selected for the gradation display, and a second preliminary driving period during which the output period of the driving signal to the gate line selected for non-gradation display overlaps the output period of the driving signal to the gate line that is driven in precedence to the gate line selected for the non-gradation display.

With the gate line driving circuit, an overlap is obtained between the output period of the driving signal to each gate line and the output period of the driving signal to the gate line that is driven in precedence to the selected gate line, and the first preliminary driving period and the second preliminary driving period are independently controlled. Specifically, even in the case where each gate line has a large time constant depending on the wiring resistance or parasitic capacitance and a transition in potential corresponding to the driving signal requires a significant length of time, the transition in the potential of the gate line selected for gradation display begins during a driving operation of a gate line that is driven in precedence, and the transition in the potential of the gate line selected for non-gradation display begins during a driving operation of a gate line that is driven in precedence. Thus, each of the potentials of the gate lines selected for gradation display and for non-gradation display is set to a desired value within the first or second preliminary driving period, thereby solving deficiency in transition of a pixel voltage to be applied to the associated pixel.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the circuit configuration of a liquid crystal display device according to an embodiment of the present invention;

FIG. 2 shows in detail a gate line driving circuit of a gate driver shown in FIG. 1;

FIG. 3 schematically shows the structure of a shift register section shown in FIG. 2; and

FIG. 4A and FIG. 4B are time charts that illustrate the operation of the gate line driving circuit shown in FIG. 2 in a case where black insertion driving is executed at a 1.25× vertical scanning speed.

### DETAILED DESCRIPTION OF THE INVENTION

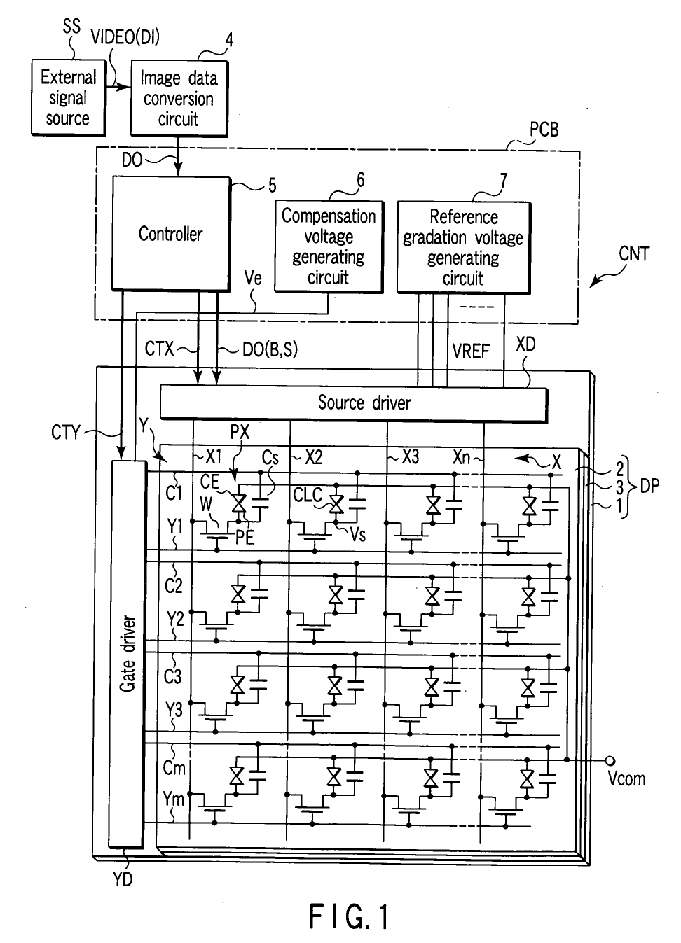

A liquid crystal display device according to an embodiment of the present invention will now be described with reference to the accompanying drawings. FIG. 1 schematically shows the circuit configuration of the liquid crystal display device. The liquid crystal display device comprises a liquid crystal display panel DP and a display panel control circuit CNT that is connected to the display panel DP. The liquid crystal display panel DP has a large size of, e.g. 32 inches in diagonal, and is configured such that a liquid crystal layer 3 is held between an array substrate 1 and a counter-substrate 2, which are a pair of electrode substrates. The liquid crystal layer 3 contains a liquid crystal material whose liquid crystal molecules are transferred in advance from a splay alignment to a bend alignment usable for a normally-white display, and are prevented from being inverse-transferred from the bend alignment to the splay alignment by a voltage for black insertion (non-gradation display) that is cyclically applied. The display panel control circuit CNT controls the transmittance of the liquid crystal display panel DP by a liquid crystal driving voltage that is applied from the array substrate 1 and counter electrode 2 to the liquid crystal layer 3. The splay alignment is transferred to the bend alignment by a relatively strong electric field applied to the liquid crystal.

The array substrate 1 includes a plurality of pixel electrodes PE that are arrayed substantially in a matrix on a transparent insulating substrate of, e.g. glass; a plurality of gate lines Y (Y1 to Ym) that are disposed along rows of the pixel electrodes PE; a plurality of storage capacitance lines C (C1 to Cm) that are disposed in parallel to the gate lines Y (Y1 to Ym) along the rows of the pixel electrodes PE; a plurality of source lines X (X1 to Xn) that are disposed along columns of the pixel electrodes PE; and a plurality of pixel switching elements W that are disposed near intersections between the gate lines Y and source lines X, each pixel switching element W being rendered conductive between the associated source line X and associated pixel electrode PE when driven via the associated gate line Y. Each of the pixel switching elements W is composed of, e.g. a thin-film transistor. The thin-film transistor has a gate connected to the associated gate line Y, and a source-drain path connected between the associated source line X and pixel electrode PE.

The counter substrate 2 includes a color filter that is disposed on a transparent insulating substrate of, e.g. glass, and a common electrode CE that is disposed on the color filter so as to be opposed to the pixel electrodes PE. Each pixel electrode PE and the common electrode CE are formed of a transparent electrode material such as ITO, and are coated with alignment films that are subjected to rubbing treatment in directions parallel to each other. To form an OCB liquid crystal pixel PX, each pixel electrode PE and the common electrode CE are associated with a pixel area of the liquid crystal layer 3 which is controlled to have a liquid crystal alignment corresponding to an electric field applied from the pixel electrode PE and common electrode CE.

Each of OCB liquid crystal pixels PX has a liquid crystal capacitance CLC between the associated pixel electrode PE and the common electrode CE. Each of the storage capacitance lines C1 to Cm constitutes storage capacitances Cs by capacitive-coupling to the pixel electrodes PE of the liquid crystal pixels on the associated row. The storage capacitance Cs has a sufficiently large capacitance value, relative to a parasitic capacitance of the pixel switching element W.

The display panel control circuit CNT includes a gate driver YD that drives the gate lines Y1 to Ym so as to turn on the switching elements W on a row-by-row basis; a source driver XD that outputs pixel voltages Vs to the source lines X1 to Xn in a time period in which the switching elements W on each row are driven by the associated gate line Y; an image data converting circuit 4 that executes, e.g. 1.25× black inserting conversion for image data included in a video signal VIDEO that is input from an external signal source SS; and a controller 5 that controls, e.g. operation timings of the gate driver YD and source driver XD in association with the conversion result. The pixel voltage Vs is a voltage that is applied to the pixel electrode PE with reference to a common voltage Vcom of the common electrode CE. The polarity of the pixel voltage Vs is reversed, relative to the common voltage Vcom, so as to execute, e.g. 4-line-unit-reversal driving and frame-reversal driving (4H1V reversal driving). The image data is composed of pixel data relating to all liquid crystal pixels PX, and is updated in units of one frame period (vertical scanning period V). In the 1.25× black inserting conversion, input pixel data DI for four rows are converted in every 4H period to pixel data B for black insertion (non-gradation display) for one row and pixel data S for gradation display for four rows, which become output pixel data DO. The pixel data S for gradation display has the same gradation value as the pixel data DI, and the pixel data B for black insertion has a gradation value for black display. Each of the pixel data B for black insertion for one row and the pixel data S for gradation display for four rows is serially output from the image data converting circuit 4 in every 4H/5 period.

The gate driver YD and source driver XD are constructed using thin-film transistors that are formed in the same fabrication steps as, e.g. the switching elements W. On the other hand, the controller 5 is disposed on an outside printed circuit board PCB. The image data converting circuit 4 is disposed further on the outside of the printed circuit board PCB. The controller 5 generates a control signal CTY for selectively driving the gate lines Y, and a control signal CTX that assigns the pixel data for black insertion or gradation display, which are serially output as a conversion result of the image data converting circuit 4, to the source lines X, and designates the signal polarity. The control signal CTY is supplied from the controller 5 to the gate driver YD. The control signal CTX is supplied from the controller 5 to the source driver XD, together with the pixel data DO that is the pixel data B for black insertion or the pixel data S for gradation display, which is obtained as a conversion result of the image data converting circuit 4.

The display panel control circuit CNT further includes a compensation voltage generating circuit 6 and a reference gradation voltage generating circuit 7. The compensation voltage generating circuit 6 generates a compensation voltage Ve that is applied via the gate driver YD to the storage capacitance line C of the row corresponding to switching elements W on one row when the switching elements W on this row are turned off, and that compensates a variation in the pixel voltage Vs, which occurs in the pixels PX on the associated row due to parasitic capacitances of these switching elements W. The reference gradation voltage generating circuit 7 generates a predetermined number of reference gradation voltages VREF that are used in order to convert the pixel data DO to the pixel voltage Vs.

Under the control of the control signal CTY, the gate driver YD selects the gate line, Y1 to Ym, for black insertion in every vertical scanning period, and delivers to the selected gate line Y a driving signal so as to render the pixel switching elements W on each row completely conductive in about every 4H/5 period. Further, the gate driver YD selects the gate line, Y1 to Ym, for gradation display in every vertical scanning period, and delivers to the selected gate line Y a driving signal so as to render the pixel switching elements W on each row completely conductive in about every 4H/5 period. The image data converting circuit 4 successively outputs the pixel data B for black insertion for one row and the pixel data S for gradation display for four rows, which are obtained as the output pixel data DO that are the result of conversion. The source driver XD refers to the predetermined number of reference gradation voltages VREF, which are delivered from the reference gradation voltage generating circuit 7, and converts the pixel data B for black insertion and the pixel data S for gradation display to the pixel voltages Vs and outputs the pixel voltages Vs to the source lines X1 to Xn in parallel.

Assume now that the gate driver YD drives the gate line Y1, for instance, by the driving voltage, and turns on all pixel switching elements W that are connected to the gate line Y1. In this case, the pixel voltages Vs on the source lines X1 to Xn are applied via the pixel switching elements W to the associated pixel electrodes PE and to terminals at one end of the associated storage capacitances Cs. In addition, the gate driver YD outputs the compensation voltage Ve from the compensation voltage generating circuit 6 to the storage capacitance line C1 that corresponds to the other terminals of the associated storage capacitances Cs. Immediately after rendering completely conductive all the pixel switching elements W, which are connected to the gate line Y1, for about 4H/5 period, the gate driver YD outputs to the gate line Y1 a non-driving voltage that turns off the pixel switching elements W. When the pixel switching elements W are turned off, the compensation voltage Ve reduces the amount of charge that leaks from the pixel electrodes PE due to the parasitic capacitances of the pixel switching elements W, thereby substantially canceling a variation in pixel voltage Vs, that is, a field-through voltage ΔVp.

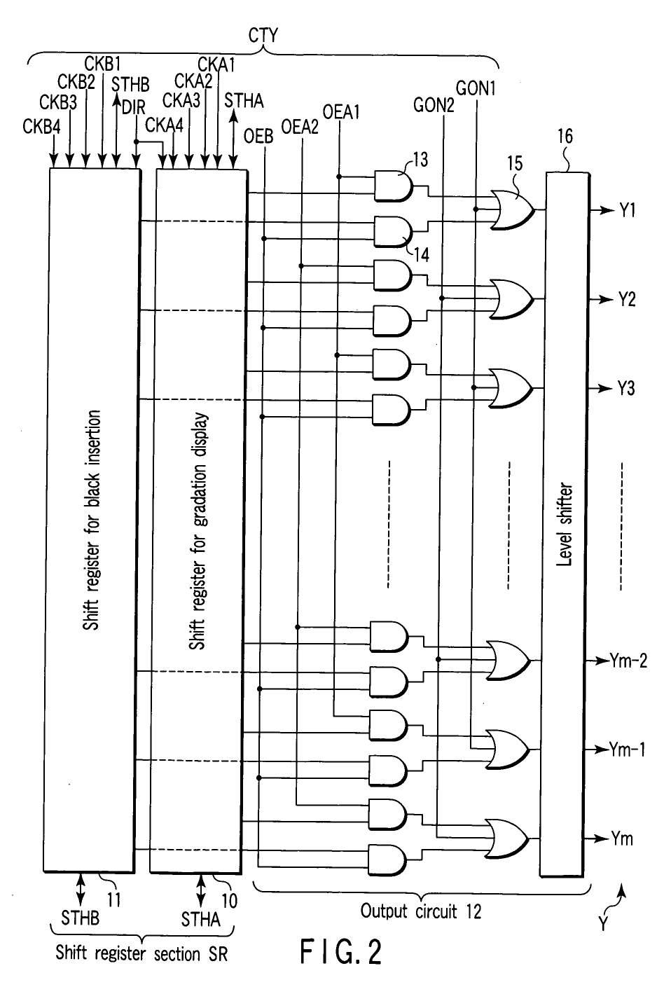

FIG. 2 shows in detail the gate line driving circuit of the gate driver YD. The gate line driving circuit includes a shift register section SR (selecting section) that selects gate lines Y1 to Ym for gradation display and black insertion, and an output circuit 12 that outputs driving signals to gate lines, which are selected for gradation display and black insertion by the shift register section SR.

Specifically, the shift register section SR comprises a shift register 10 for gradation display (first shift register), which shifts a first start signal STHA in response to first clock signals CKA1 to CKA4, and a shift register 11 for black insertion (second shift register), which shifts a second start signal STHB in response to second clock signals CKB1 to CKB4 synchronous with the first clock signals CKA1 to CKA4. The output circuit 12 is configured to output a driving signal, under control of one of a first output enable signal OEA1 and a second output enable signal OEA2, to the gate line Y that is selected in accordance with the shift position of the first start signal STHA stored in the shift register 10 for gradation display, and a driving signal, under control of a third output enable signal OEB, to the gate line Y that is selected in accordance with the shift position of the second start signal STHB stored in the shift register 11 for black insertion. The gate lines Y1 to Ym are divided into a first gate line group including odd-numbered gate lines Y1, Y3, Y5, . . . , and a second gate line group including even-numbered gate lines Y2, Y4, Y6, . . . . The first and second groups are alternately selected by a first group selection signal GON1 and a second group selection signal GON2 in an initializing process for all the OCB liquid crystal pixels PX. The first group selection signal GON1, second group selection signal GON2, first clock signals CKA1 to CKA4, first start signal STHA, second clock signals CKB1 to CKB4, second start signal STHB, first output enable signal OEA1, second output enable signal OEA2 and third output enable signal OEB are all included in the control signal CTY that is supplied from the controller 5.

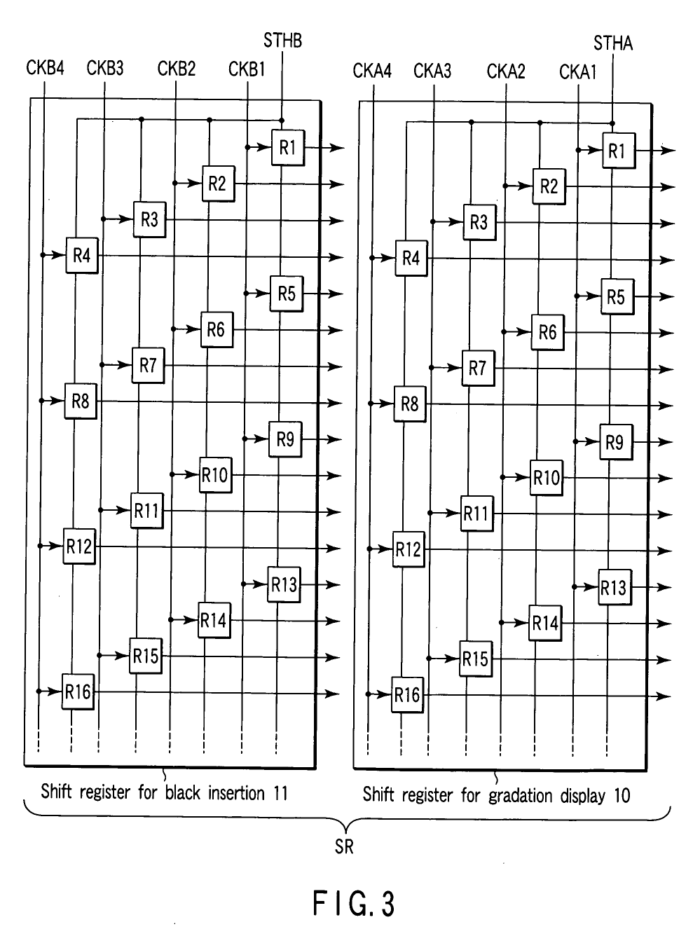

FIG. 3 schematically shows the structure of the shift register section SR. Each of the shift register 10 for gradation display and the shift register 11 for black insertion comprises an m-number of registers R1 to Rm, which are assigned to the gate lines Y1 to Ym and connected in such a manner that every fourth register is connected in series. Specifically, the registers R1, R5, R9, R13, . . . , are connected in series as a first sub-shift register, the registers R2, R6, R10, R14, . . . , are connected in series as a second sub-shift register, the registers R3, R7, R11, R15, . . . , are connected in series as a third sub-shift register, and the registers R4, R8, R12, R16, . . . , are connected in series as a fourth sub-shift register. Each of the first start signal STHA and second start signal STHB are input in a parallel fashion to the associated registers R1, R2, R3 and R4 that are assigned to the gate lines Y1, Y2, Y3 and Y4. In the shift register 10 for gradation display, the first sub-shift register shifts the first start signal STHA in a direction from the register R1 toward the register Rm-3 in response to the first clock signal CKA1. The second sub-shift register shifts the first start signal STHA in a direction from the register R2 toward the register Rm-2 in response to the first clock signal CKA2. The third sub-shift register shifts the first start signal STHA in a direction from the register R3 toward the register Rm-1 in response to the first clock signal CKA3. The fourth sub-shift register shifts the first start signal STHA in a direction from the register R4 toward the register Rm in response to the first clock signal CKA4. In the shift register 11 for black insertion, the first sub-shift register shifts the second start signal STHB in a direction from the register R1 toward the register Rm-3 in response to the second clock signal CKB1. The second sub-shift register shifts the second start signal STHB in a direction from the register R2 toward the register Rm-2 in response to the second clock signal CKB2. The third sub-shift register shifts the second start signal STHB in a direction from the register R3 toward the register Rm-1 in response to the second clock signal CKB3. The fourth sub-shift register shifts the second start signal STHB in a direction from the register R4 toward the register Rm in response to the second clock signal CKB4. Each of all registers R1 to Rm in the shift register 10 for gradation display has an output terminal that outputs a selection signal for the associated gate line Y, which rises to a high level while the first start signal STHA is being retained. Each of all registers R1 to Rm in the shift register 11 for black insertion has an output terminal that outputs a selection signal for the associated gate line Y, which rises to a high level while the second start signal STHB is being retained.

The output circuit 12 includes an m-number of AND gate circuits 13, an m-number of AND gate circuits 14, an m-number of OR gate circuits 15 and a level shifter 16. The m-number of AND gate circuits 13 are so connected as to output the selection signals for the gate lines Y1 to Ym, which are obtained from the shift register 10 for gradation display, to the m-number of OR gate circuits 15 under the control of one of the first output enable signal OEA1 and second output enable signal OEA2. The first output enable signal OEA1 permits all the odd-numbered AND gate circuits 13 to output the selection signals in the state in which the first output enable signal OEA1 is set at a high level, and the first output enable signal OEA1 prohibits all the odd-numbered AND gate circuits 13 from outputting the selection signals in the state in which the first output enable signal OEA1 is set at a low level. The second output enable signal OEA2 permits all the even-numbered AND gate circuits 13 to output the selection signals in the state in which the second output enable signal OEA2 is set at a high level, and the second output enable signal OEA2 prohibits all the even-numbered AND gate circuits 13 from outputting the selection signals in the state in which the second output enable signal OEA2 is set at a low level. The m-number of AND gate circuits 14 are so connected as to output the selection signals for the gate lines Y1 to Ym, which are obtained from the shift register 11 for black insertion, to the m-number of OR gate circuits 15 under the control of the third output enable signal OEB. The third output enable signal OEB permits all the AND gate circuits 14 to output the selection signals in the state in which the third output enable signal OEB is set at a high level, and the third output enable signal OEB prohibits all the AND gate circuits 14 from outputting the selection signals in the state in which the third output enable signal OEB is set at a low level. The first output enable signal OEA1 is set at the high level only during a predetermined period that is obtained by adding a first preliminary driving period, which corresponds to a time constant depending on the wiring resistance and parasitic capacitance of each gate line Y, before and after a 4H/5 period that is an output period of the pixel voltage Vs, which is output for gradation display from the source driver XD to the pixels PX on the odd-numbered rows. The second output enable signal OEA2 is set at the high level only during a predetermined period that is obtained by adding a first preliminary driving period, which corresponds to a time constant depending on the wiring resistance and parasitic capacitance of each gate line Y, before and after a 4H/5 period that is an output period of the pixel voltage Vs, which is output for gradation display from the source driver XD to the pixels PX on the even-numbered rows. Further, the third output enable signal OEB is set at the high level only during a predetermined period that is obtained by adding a second preliminary driving period, which corresponds to a time constant depending on the wiring resistance and parasitic capacitance of each gate line Y, before and after a 4H/5 period that is an output period of the pixel voltage Vs, which is output for black insertion from the source driver XD to the pixels PX on the four rows. In this case, the predetermined period is less than an 8H/5 period. The first preliminary driving period is a period during which the output period of the driving signal to the gate line selected for gradation display overlaps the output period of the driving signal to the gate line that is driven in precedence to the gate line selected for the gradation display. The second preliminary driving period is a period during which the output period of the driving signal to the gate line selected for black insertion (non-gradation display) overlaps the output period of the driving signal to the gate line that is driven in precedence to the gate line selected for the black insertion. The output circuit 12 independently controls the first and second preliminary driving periods.

Each of the m-number of OR gate circuits 15 inputs the selection signal from the associated AND gate circuit 13 and the selection signal from the associated AND gate circuit 14 to the level shifter 16. Half of the m-number of OR gate circuits 15 are used for odd-numbered gate lines, and input the first group selection signal GON1 to the level shifter 16 as the selection signals for the odd-numbered gate lines, Y1, Y3, Y5, . . . . The other half of the OR gate circuits 15 are used for even-numbered gate lines, and input the second group selection signal GON2 to the level shifter 16 as the selection signals for the even-numbered gate line, Y2, Y4, Y6, . . . . The level shifter 16 is configured to shift the level of the voltages of the selection signals that are input from the m-number of OR gate circuits 15, thereby converting the voltages to driving signals for turning on the polysilicon thin-film transistors W, and delivering the driving signals to the gate lines Y1 to Ym.

The directions of shift of the first start signal STHA and second start signal STHB can be changed by a scan direction signal DIR that is supplied from the controller 5 to the registers R1 to Rm of the shift register 10 for gradation display and to the registers R1 to Rm of the shift register 11 for black insertion.

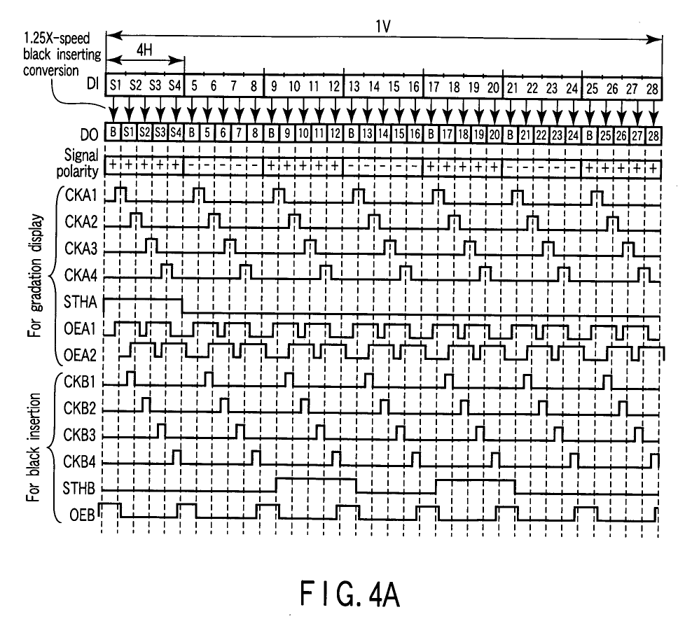

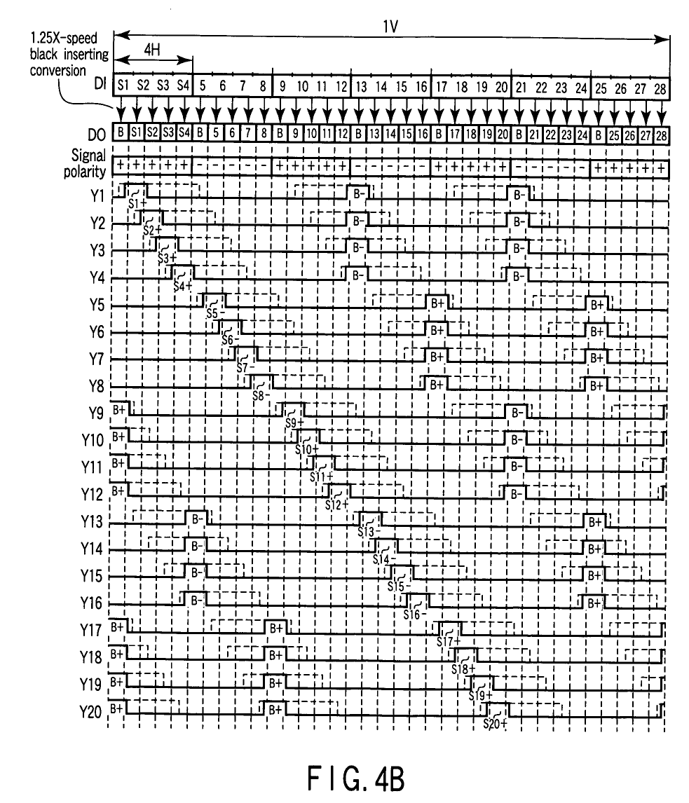

FIGS. 4A and 4B illustrate the operation of the gate line driving circuit in a case where black insertion driving is executed at a 1.25× vertical scanning speed. In FIGS. 4A and 4B, symbol B represents pixel data for black insertion, which is common to the pixels PX of the respective rows, and S1, S2, S3, . . . , designate pixel data for gradation display, which are associated with pixels PX on the first row, pixels PX on the second row, pixels PX on the third row, etc. Symbols + and − represent signal polarities at a time when the pixel data B, S1, S2, S3, . . . , are converted to pixel voltages Vs and output from the source driver XD.

The first start signal STHA is a pulse that is input to the shift register 10 for gradation display with a pulse width corresponding to a 4H period. Each of the first clock signals CKA1 to CKA4 is a 4H-cycle pulse that is input to the shift register 10 for gradation display at a rate of one pulse per 4H period. As is shown in FIG. 4A, the clock signals CKA2 to CKA4 are input with a phase shift of 4H/5, relative to the clock signals CKA1 to CKA3. In addition, there is a phase difference of 8H/5 between the pulse of the clock signal CKA4 and the pulse of the subsequent clock signal CKA1. The shift register 10 for gradation display shifts the first start signal STHA in response to the first clock signals CKA1 to CKA4, and outputs, in every 4H period, the selection signals for sequentially selecting the gate lines Y1 to Ym. In this scheme, the pulses of the first clock signals CKA1 to CKA4 are raised to a high level in the first to fourth 4H/5 periods in the 4H period. The m-number of AND gate circuits 13 output, under the control of one of the first output enable signal OEA1 and second output enable signal OEA2, the selection signals, which are sequentially obtained from the shift register 10 for gradation display, to the m-number of OR gate circuits 15 during predetermined time periods, in which first preliminary driving periods are added before and after the second to fifth 4H/5 periods in the associated 4H period. Specifically, the odd-numbered AND gate circuits 13 output the selection signals for the odd-numbered gate lines Y only during predetermined time periods, in which first preliminary driving periods are added before and after the second and fourth 4H/5 periods in the associated 4H period. The even-numbered AND gate circuits 13 output the selection signals for the even-numbered gate lines Y only during first predetermined time periods, in which preliminary driving periods are added before and after the third and fifth 4H/5 periods in the associated 4H period. Each selection signal is supplied from the associated OR gate circuit 15 to the level shifter 16. The level shifter 16 converts the selection signal to a driving signal and outputs it to the associated gate line Y. Besides, the source driver XD converts each of the pixel data for gradation display, S1, S2, S3, . . . , to the pixel voltages Vs in the second to fifth4H/5 periods in the associated 4H period, and outputs the pixel voltages Vs in parallel to the source lines X1 to Xn with the polarity that is reversed in every4H period. The pixel voltages Vs are applied to the liquid crystal pixels PX on the first to fourth rows, the fifth to eighth rows, the ninth to twelfth rows, . . . , on a row-by-row basis, while each of the gate lines Y1 to Ym is driven with reference to the second to fifth 4H/5 periods in the associated 4H period.

On the other hand, the second start signal STHB is a pulse that is input to the shift register 11 for black insertion with a pulse width corresponding to a 4H period. Each of the second clock signals CKB1 to CKB4 is a 4H-cycle pulse that is input to the shift register 11 for black insertion at a rate of one pulse per 2H period. As is shown in FIG. 4A, the clock signals CKB2 to CKB4 are input with a phase shift of 4H/5, relative to the clock signals CKB1 to CKB3. In addition, there is a phase difference of 8H/5 between the pulse of the clock signal CKB4 and the pulse of the subsequent clock signal CKB1. The shift register 11 for black insertion shifts the second start signal STHB in response to the second clock signals CKB1 to CKB4, and outputs, in every 4H period, the selection signals for sequentially selecting the gate lines Y1 to Ym. In this scheme, the pulses of the second clock signals CKB1 to CKB4 are raised to a high level in the second to fifth 4H/5 periods in the 4H period. The m-number of AND gate circuits 14 output, under the control of third output enable signal OEB, the selection signals, which are sequentially obtained from the shift register 11 for black insertion, to the m-number of OR gate circuits 15 in units of signals for four lines during a predetermined time period in which second preliminary driving periods are added before and after the first 4H/5 period in the associated 4H period. Each selection signal is supplied from the associated OR gate circuit 15 to the level shifter 16. The level shifter 16 converts the selection signal to a driving signal and outputs it to the associated gate line Y. Besides, the source driver XD converts each of the pixel data for black insertion, B, B, B, . . . , to the pixel voltages Vs in the first 4H/5 period in the associated 4H period, and outputs the pixel voltages Vs in parallel to the source lines X1 to Xn with the polarity that is reversed in every 4H period. The pixel voltages Vs are applied to the liquid crystal pixels PX on the first to fourth rows, the fifth to eighth rows, the ninth to twelfth rows, . . . , in units of four rows, while each of the gate lines Y1 to Ym is driven with reference to the first 4H/5 period in the associated 4H period. In FIG. 4A, the first start signal STHA and second start signal STHB are input with a relatively short interval. Actually, the first start signal STHA and second start signal STHB are input with a relatively long interval so that the ratio of a voltage storage period for black insertion to a voltage storage period for gradation display may accord with a black insertion ratio. In addition, it is preferable to input the second start signal STHB once again with a delay of 8H after the first input of the second start signal STHB. Thereby, each gate line Y is driven twice for black insertion. Accordingly, even in the case where it is difficult to shift the potential of the associated pixel electrode PE up to a high pixel voltage Vs for black insertion within a short period of 4H/5, the pixel voltage Vs can surely be set in the pixel electrode PE. The above-mentioned 8H delay is needed in order to uniformize the polarity of the pixel voltages Vs for black insertion. In the meantime, black insertion for the pixels PX near the last row is continuous from the preceding frame, for example, as shown in the lower left part of FIG. 4B.

In the present embodiment, the output period of the driving signal to each selected gate line Y partially overlaps the output period of the driving signal to the gate line Y that is driven in precedence to the selected gate line Y. Specifically, even in the case where each selected gate line Y has a large time constant depending on the wiring resistance or parasitic capacitance and a variation in potential corresponding to the driving signal requires a significant length of time, the potential begins to vary while the gate line Y that is driven in precedence is being driven. Thus, by the time the driving of the gate line Y that is driven in precedence is completed, the associated switching element W can be approached to the complete conductive state. It is thus possible to solve the problem of the deficiency in transition of the pixel voltage, which is applied to the liquid crystal pixel PX via the switching element.

The present invention is not limited to the above-described embodiment, and various modifications can be made without departing from the spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gate line driving circuit that drives a plurality of gate lines, which are assigned to rows of pixels arranged substantially in a matrix, said gate line driving circuit comprising:
a selecting section that selects the gate lines for gradation display and for non-gradation display; and
an output circuit that outputs a driving signal to the gate line which is selected by the selecting section, said output circuit being configured to obtain an overlap between an output period of a driving signal to each selected gate line and an output period of a driving signal to a gate line that is driven in precedence to the selected gate line, and independently control a first preliminary driving period during which the output period of the driving signal to the gate line selected for gradation display overlaps the output period of the driving signal to the gate line that is driven in precedence to the gate line selected for the gradation display, and a second preliminary driving period during which the output period of the driving signal to the gate line selected for non-gradation display overlaps the output period of the driving signal to the gate line that is driven in precedence to the gate line selected for the non-gradation display.

2. The gate line driving circuit according to claim 1, wherein each preliminary driving period corresponds to a time constant that depends on a wiring resistance and a parasitic capacitance of the associated gate line.

3. The gate line driving circuit according to claim 1, wherein said selecting section is configured such that said gate lines are sequentially selected for gradation display in units of one gate line in one vertical scanning period, and are sequentially selected for non-gradation display in units of at least two gate lines in a period substantially equal to the vertical scanning period.

4. The gate line driving circuit according to claim 3, wherein the selecting section includes a first shift register which shifts a first start signal for gradation display in response to a first clock signal, and a second shift register which shifts a second start signal for non-gradation display in response to a second clock signal, and said output circuit is configured to output, under control of a first output enable signal, a driving signal to the odd-numbered gate line selected by said first shift register, to output, under control of a second output enable signal, a driving signal to the even-numbered gate line selected by said first shift register, and to output, under control of a third output enable signal, a driving signal to the gate line selected by said second shift register.

5. The gate line driving circuit according to claim 4, wherein said output circuit includes:
a plurality of first AND gate circuits that are divided into a group, which outputs, under control of the first output enable signal, the selection signal for the odd-numbered gate line that is obtained for gradation display from said first shift register, and a group, which outputs, under control of the second output enable signal, the selection signal for the even-numbered gate line that is obtained for gradation display from said first shift register;
a plurality of second AND gate circuits, each of which outputs, under control of the third output enable signal, a selection signal for the associated gate line, which is obtained for non-gradation display from the second shift register;
a plurality of OR gate circuits, each of which outputs the selection signal for the associated gate line, which is input from one of the first AND gate circuits and one of the second AND gate circuits; and
a level shifter that shifts a level of the selection signal, which is output from each of the plurality of OR gate circuits to convert the selection signal to the driving signal.
